(19) United States
(12) Patent Application Publication
(10) Pub. No.: US 2026/0138880 A1
(43) Pub. Date: May 21, 2026

(54) Enhancing Carbon Dioxide Storage via Bio-Inspired Mineralization of Vaterite Microspheres Using Ultrasonication and Bio-additives

(71) Applicant: UNM RAINFOREST INNOVATIONS, Albuquerque, NM (US)

(72) Inventors: Sungjin KIM, Albuquerque, NM (US); Sang M. HAN, Albuquerque, NM (US); Sang Eon HAN, Albuquerque, NM (US); Maryam HOJATI, Albuquerque, NM (US); Leila SHAHRIARI, Albuquerque, NM (US)

(73) Assignee: UNM RAINFOREST INNOVATIONS, Albuquerque, NM (US)

(21) Appl. No.: 19/392,629

(22) Filed: Nov. 18, 2025

Related U.S. Application Data
(60) Provisional application No. 63/721,623, filed on Nov. 18, 2024.

(51) Int. Cl. C01F 11/18; B01D 71/34

(52) U.S. Cl. CPC C01F 11/183; B01D 71/34; C01F 11/181; C01F 11/185; C01P 2004/61; C01P 2004/62

(57) ABSTRACT

A carbon dioxide mineralization process is disclosed, which includes introducing ammonium hydroxide solution and a calcium chloride solution into a reaction vessel to form a mixed solution, introducing carbon dioxide gas into the reaction vessel, and forming a calcium carbonate precipitate. Implementations of the carbon dioxide mineralization process can include where the mixed solution further may include tannic acid. A concentration of tannic acid can be from about 0 mg/mL to about 2 mg/mL. A flow rate of the introduction of carbon dioxide gas can be from about 0 L/min to about 1.0 L/min. The carbon dioxide mineralization process may include providing ultrasonic energy at a frequency of from about 20 khz to about 130 khz to the mixed solution. The carbon dioxide mineralization process may include filtering the calcium carbonate precipitate through a polyvinylidene fluoride membrane. The calcium carbonate precipitate may include a metastable vaterite phase.

### REFERENCE TO RELATED APPLICATIONS

This application claims the benefit of U.S. Provisional Patent Application No. 63/721,623, filed on Nov. 18, 2024, which is hereby incorporated by reference in its entirety.

### TECHNICAL FIELD

The present teachings relate generally to carbon dioxide storage and, more particularly, to mineralization of carbon dioxide and processes thereof.

### BACKGROUND

The escalating levels of anthropogenic greenhouse gas emissions, mainly CO₂, which reached an alarming concentration of 421 ppm as of 2022, have created a pressing need to accurately monitor environmental data, implement effective mitigation strategies, and develop approaches for converting CO₂ into value-added products. CO₂ mineralization, involving the reaction of CO₂ with alkaline wastes or natural minerals to form stable carbonates, emerges as a promising strategy for long-term CO₂ utilization and storage, potentially mitigating climate change. Among carbonate minerals, calcium carbonate is one of the most widely used inorganic minerals. Numerous efforts have been undertaken to adjust the crystallographic phases and morphologies of CaCO₃ particles, drawing inspiration from natural biogenic systems that produce complex biomineral structures with remarkable morphologies and properties. However, controlling polymorphs and the morphology of minerals with specific added value for target applications while improving carbonate yield has been a limiting factor.

Therefore, it is desirable to develop processes, methods, or materials that can utilize mineralization reactions involving CO₂ or perhaps other reactants to effectively utilize waste materials and convert these to useful engineering materials having controlled properties and structures.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A carbon dioxide mineralization process is disclosed. The carbon dioxide mineralization process includes introducing ammonium hydroxide solution and a calcium chloride solution into a reaction vessel to form a mixed solution, introducing carbon dioxide gas into the reaction vessel, and forming a calcium carbonate precipitate. Implementations of the carbon dioxide mineralization process can include where the mixed solution further may include tannic acid. A concentration of tannic acid can be from about 0 mg/mL to about 2 mg/mL. The carbon dioxide mineralization process can be conducted at a temperature from about 20° C. to about 30° C. A flow rate of the introduction of carbon dioxide gas can be from about 0 L/min to about 1.0 L/min. A reaction time of the carbon dioxide mineralization process can be from about 5 minutes to about 60 minutes. The carbon dioxide mineralization process may include providing ultrasonic energy at a frequency of from about 20 khz to about 130 khz to the mixed solution. The carbon dioxide mineralization process may include filtering the calcium carbonate precipitate through a polyvinylidene fluoride membrane. A concentration of calcium chloride can be from about 0.033 M to about 0.33 M. The carbon dioxide mineralization process may include washing the calcium carbonate precipitate, and drying the calcium carbonate precipitate under a vacuum. A particle size of the calcium carbonate precipitate is from about 0.5 microns to about 10 microns. The calcium carbonate precipitate may include a metastable vaterite phase.

A process for forming calcium carbonate is disclosed. The process for forming calcium carbonate includes introducing an ammonium hydroxide solution and a calcium chloride solution into a reaction vessel to form a mixed solution, introducing carbon dioxide gas into the reaction vessel, and forming a calcium carbonate precipitate, the calcium carbonate precipitate may include a metastable vaterite polymorph phase. Implementations of the process for forming calcium carbonate include where the mixed solution further may include tannic acid. A concentration of tannic acid can be from about 0 mg/mL to about 2 mg/mL. A flow rate of the introduction of carbon dioxide gas can be from about 0.1 L/min to about 1.0 L/min. The process for forming calcium carbonate may include providing ultrasonic energy at a frequency of from about 20 khz to about 130 khz to the mixed solution. A concentration of calcium chloride can be from about 0.033 M to about 0.33 M. The process for forming calcium carbonate may include washing the calcium carbonate precipitate, and drying the calcium carbonate precipitate under a vacuum. A yield of the calcium carbonate precipitate is from about 246.7 g/kg to about 1173.8 g/kg. A particle size of the calcium carbonate precipitate is from about 0.5 microns to about 6 microns.

The features, functions, and advantages that have been discussed can be achieved independently in various implementations or can be combined in yet other implementations, further details of which can be seen with reference to the following description.

### BRIEF DESCRIPTION OF THE DRAWINGS

The accompanying drawings, which are incorporated in and constitute a part of this specification, illustrate embodiments of the present teachings and, together with the description, serve to explain the principles of the disclosure. In the figures:

FIG. 1 is a schematic of an experimental setup and process utilizing a bio-mimetic mineralization process, in accordance with the present disclosure.

FIGS. 2A-2C are scanning electron microscope (SEM) images of precipitated carbonate formed using 0.33 M CaCl₂ without tannic acid (TA) (W/O TA) and with 1 mg/mL TA (W/TA) after one hour of CO₂ injection with 0.1 L/min flow rate without ultrasound irradiation and an X-Ray Diffraction (XRD) spectra of the related particles, respectively, in accordance with the present disclosure.

FIGS. 3A-3D are SEM images of calcium carbonate crystals formed with 2 mg/mL TA with different CO₂ flow rate and Ca²⁺ concentration without ultrasonication: 0.33 M CaCl₂ after 5 minutes with 0.1 L/min CO₂ flow rate (FIG. 3A), 0.33 M CaCl₂) after 5 minutes with 1 L/min CO₂ flow rate (FIG. 3B), 0.033 M CaCl₂) after 60 minutes with 1 L/min CO₂ flow rate (FIG. 3C), and 0.33 M CaCl₂ after 60 minutes with 1 L/min CO₂ flow rate (FIG. 3D), respectively, in accordance with the present disclosure.

FIGS. 4A-4L Shows a series of plots and depictions of experiments directed to exploring product yield with (W/) and without (W/O) ultrasound after 1 hour with TA concentrations of 0, 1, and 2 mg/mL under: (FIG. 4A) 0.033 M CaCl₂) at 0.1 L/min CO₂ flow rate, and (FIG. 4B) 0.033 M CaCl₂) at 1 L/min CO₂ flow rate. Photos of CO₂ bubbling: (FIG. 4C) W/O and (FIG. 4D) W/ultrasonication in 2 mg/mL TA concentrations at 1 L/min CO₂. SEM images and particle size histogram of CaCO₃ crystals formed with 0.033 M CaCl₂) after one hours of 1 L/min CO₂ injection, for (FIG. 4E) 0, (FIG. 4F) 1, (FIG. 4G) 2 mg/mL TA W/O ultrasonication and (FIG. 4H) its particle size distribution and (FIG. 4I) 0, (FIG. 4J) 1, (FIG. 4K) 2 mg/mL TA w/ultrasonication and (FIG. 4L) its particle size distribution, in accordance with the present disclosure.

FIGS. 5A-5E depict plots and scanning electron microscope images of CaCO₃. Product yield result after 5, 30, and 60 minutes with TA concentrations of 0, 1, and 2 mg/mL under (FIG. 5A) 0.033 M CaCl₂) at 0.1 L/min CO₂ flow rate and (FIG. 5B) 0.033 M CaCl₂) at 1 L/min CO₂ flow rate. SEM images and particle size distribution of CaCO₃ crystals formed with 0.033 M CaCl₂) at 1 L/min CO₂ flow rate after 5 minutes (FIG. 5C), 30 minutes (FIG. 5D), and 60 minutes (FIG. 5E), with 2 mg/mL TA in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In the studies described in the present disclosure, carbonate yield was optimized while simultaneously controlling the polymorph and morphology of calcium carbonate. This was achieved by fine-tuning CO₂ flow rates and employing ultrasound in the presence of tannic acid (TA), a plant-derived polyphenol that mimics the adhesive properties of mussel foot proteins. It can be demonstrated that calcium carbonate yields can be enhanced nearly threefold while also producing fine spherical vaterite particles of 1-2 μm in size through this process.

### Material and Methods

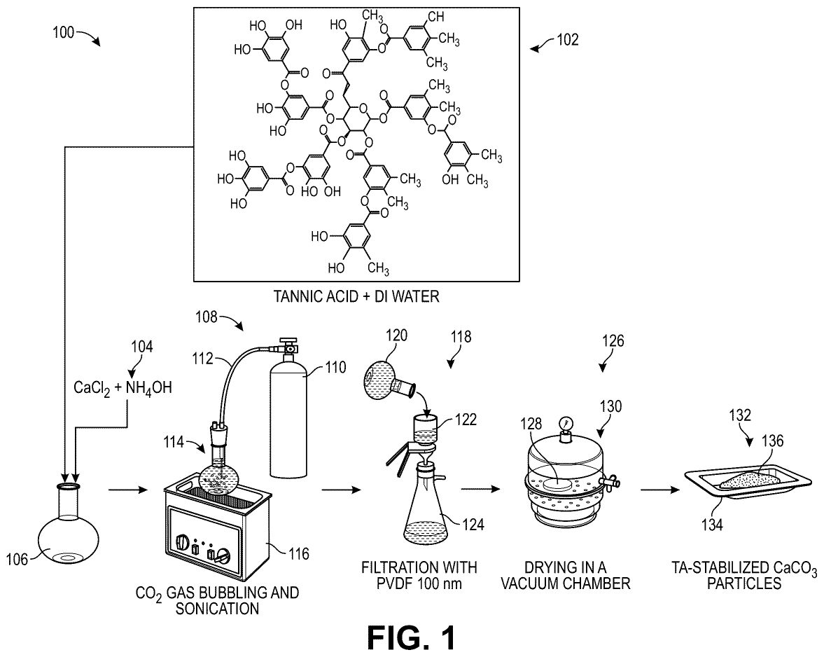

FIG. 1 is a schematic of an experimental setup and process utilizing a bio-mimetic mineralization process, in accordance with the present disclosure. Tannic acid (TA) and calcium chloride (CaCl₂)) were obtained from Sigma-Aldrich and Avantor, respectively. The CO₂ mineralization reaction was conducted at room temperature in a gas-bubbling setup (FIG. 1). CO₂ gas was introduced at flow rates of 0.1 and 1 L/min for durations of 5, 30, and 60 minutes in an aqueous mixture of CaCl₂) (0.033 or 0.33 M) and NH₄OH (5 M). Experiments were conducted with and without ultrasonication using an ultrasonic cleaner FS20 (42 KHz frequency), and TA concentrations were varied (0, 1, and 2 mg/mL) to optimize the process. The resulting precipitates were collected by filtration through 0.1 μm polyvinylidene fluoride (PVDF) membranes by Millipore, thoroughly washed with deionized water, and vacuum-dried for at least 24 hours before characterization.

The experimental setup and process 100 shown in FIG. 1 begins with a mixing of tannic acid 102 and deionized water with calcium chloride and ammonia 104 into a reaction vessel 106. Next is a carbon dioxide gas bubbling and sonication 108 step, where a carbon dioxide gas source 110 provides carbon dioxide via a gas delivery 112 tube or pathway into the reaction vessel 114, which is placed into a sonication unit 116 where it can be subjected to ultrasonication. The filtration step 118 includes pouring the contents from the reaction vessel 120 into a filter assembly 122 having a 0.1 μm polyvinylidene fluoride (PVDF) membrane filter as described herein and filtering into a collection flask 124. Next, a drying step 126 is conducted, where a dish of reaction product 128 is placed inside of a vacuum chamber 130. Finally, a collection 132 of stabilized calcium carbonate particles 136 into a collection dish 134 is completed.

In examples of the present disclosure, a carbon dioxide mineralization process can include introducing ammonium hydroxide solution and a calcium chloride solution into a reaction vessel to form a mixed solution, introducing carbon dioxide gas into the reaction vessel, and forming a calcium carbonate precipitate. The mixed solution can, in examples, include tannic acid. Tannic acid has been added as an additive to the solution to assess its role in altering the mineralization pathway in the presence of CaCl₂) and ammonium hydroxide. In exemplary procedures, the concentration of calcium chloride or its alternatives can be from about 0.033 M to about 0.33 M. As described herein, calcium chloride was used at concentrations of 0.033 M and 0.33 M, though intermediate concentrations can be considered as applicable as well. Other Ca-bearing precursors, including calcium hydroxide (Ca(OH)₂), calcium oxide (CaO), or calcium-rich waste, may serve as alternatives: however, variations from the results reported herein can be anticipated. In other exemplary procedures, the concentration of tannic acid, or its alternatives can be from about 0.1 mg/mL to about 2 mg/mL, or from about 0.1 mg/mL to about 1 mg/mL, or from about 0.25 mg/mL to about 0.75 mg/mL. It should be noted that intermediate concentrations and variations from the results reported herein should be anticipated. The carbon dioxide mineralization process can be conducted at a temperature from about 20° C. to about 30° C. While most the reactions herein were performed at room temperature, higher or lower temperatures can influence the yield, polymorph, and morphology of the particles. The flow rate of the introduction of carbon dioxide gas can be from about 0.1 L/min to about 5.0 L/min, or from about 0.1 L/min to about 2.5 L/min, or from about 0.1 L/min to about 1.0 L/min. While CO₂ flow rates of 0.1 and 1 L/min were used, higher CO₂ flow rates can impact CO₂ adsorption and solubility in the solution and therefore become limiting. The reaction time in the carbon dioxide mineralization process can be from about 1 minute to about 120 minutes, or from about 5 minutes to about 90 minutes, or from about 5 minutes to about 60 minutes. In examples of the carbon dioxide mineralization process, the step of providing ultrasonic energy at a frequency of 42 kHz to the mixed solution can be included. Different frequency ranges can be applied depending on the equipment used, for example, from about 20 kHz to about 130 kHz. Other methods for reducing particle size, such as probe sonication or ball milling, are also possible, although different outcomes can be potentially expected. Once the initial steps of the carbon dioxide mineralization process are complete, filtering the calcium carbonate precipitate through a polyvinylidene fluoride membrane, with or without the use of vacuum can be conducted. Washing the precipitate with DI water multiple times and drying the calcium carbonate precipitate at room temperature or below 50° C., under a vacuum can also be conducted. In examples of the carbon dioxide mineralization process, the yield of the precipitated product can range from about 246.6 g/kg to about 1173.8 g/kg. Specifically, in the ultrasound-assisted process with 2 mg/mL TA at a CO₂ flow rate of 0.1 L/min, the product yield increased by ˜2.76-fold (176%), rising from 424.6 to 1173.8 g/kg compared with the condition without TA and ultrasonication. A similar trend was observed at a CO₂ flow rate of 1 L/min, where the yield increased by about 4-fold (300%), from 247.9 to 995.4 g/kg. A final particle size, expressed in terms of a mean particle size distribution, of the calcium carbonate precipitate can be from about 0.5 microns to about 10 microns, or from about 2.0 microns to about 7.0 microns, from about 0.5 microns to about 10 microns. In practicing the carbon mineralization method as described herein, the calcium carbonate precipitate includes a metastable vaterite phase. A metastable vaterite phase is a form of calcium carbonate that in examples can transform into more stable polymorphs such as calcite or aragonite. Characteristics of the metastable vaterite phase include its ability to transform into more stable forms of calcium carbonate like calcite when processed under ambient conditions, or aragonite when processed at higher temperatures using a process of dissolution and recrystallization.

### Characterization

CaCO₃ samples were characterized using scanning electron microscopy (SEM-JSM-IT100 In TouchScope) in secondary electron mode to analyze particle shape and size. Crystallographic analysis was performed using powder X-ray diffraction (XRD, Rigaku SmartLab).

### Data Analytical Methods

The product yield, X_{Product} (g/kg), was calculated by Eq. 1.

$${X}_{P r o d u c t} = ( {m}_{P r o d u c t} / {m}_{Calcium chloride} \times 1000 ) \qquad ( 1 )$$

where m_{Product} is the mass of precipitated product (g), and m_{Calcium chloride} is the initial mass of calcium chloride (g).

### Results and Discussion

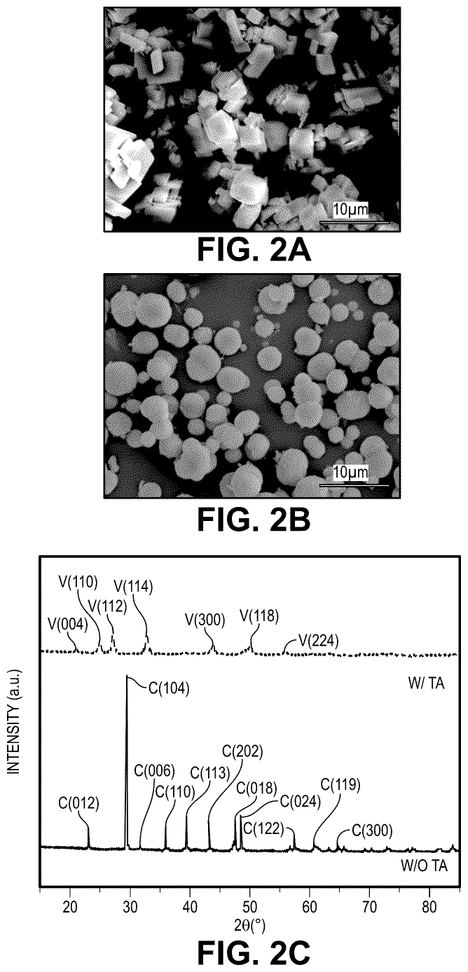

FIGS. 2A-2C are scanning electron microscope (SEM) images of calcium carbonate crystals formed using 0.33 M CaCl₂ without tannic acid, with 1 mg/mL tannic acid after one hour of reaction with a 0.1 L/min CO₂ flow rate, and an X-Ray Diffraction spectra of the related particles, respectively, in accordance with the present disclosure. The formation of spherical CaCO₃ crystals was observed in a reaction containing TA (1 mg/mL) using SEM (FIGS. 2A and 2B). The XRD pattern confirmed the presence of the calcite polymorph in the absence of TA, while intensities for the vaterite polymorph dominated in the presence of TA, as shown in FIG. 2C. This effect can be attributed to the deprotonated phenolic groups of TA, which act as polydentate ligands, creating strong metal chelation. This chelation induces and preserves the metastable vaterite phase by retarding the formation of calcite.

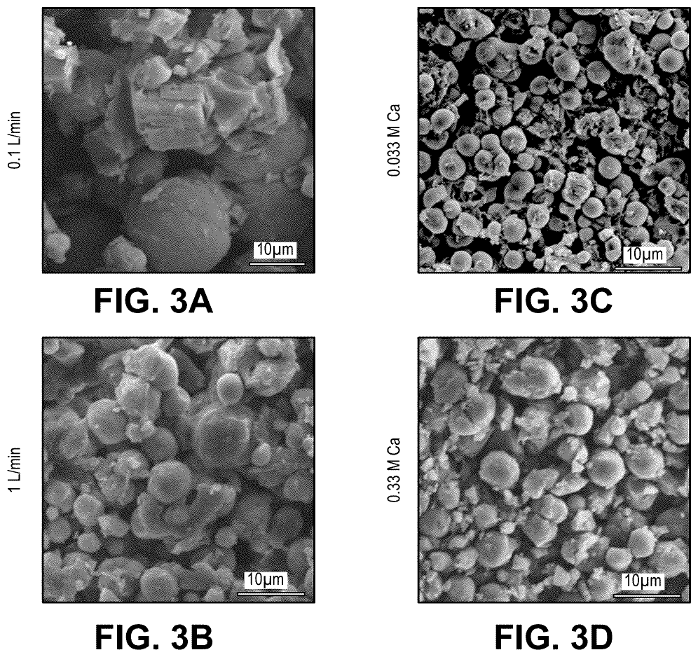

FIGS. 3A-3D are scanning electron microscope (SEM) images of calcium carbonate crystals formed with 2 mg/mL tannic acid and a CO₂ flow rate and Ca²⁺ concentration without ultrasonication: 0.33 M CaCl₂ after 5 minutes with 0.1 L/min CO₂ flow rate (FIG. 3A), 0.33 M CaCl₂ after 5 minutes with 1 L/min CO₂ flow rate (FIG. 3B), 0.033 M CaCl₂ after 60 minutes with 1 L/min CO₂ flow rate (FIG. 3C), and 0.33 M CaCl₂ after 60 minutes with 1 L/min CO₂ flow rate (FIG. 3D), respectively, in accordance with the present disclosure. SEM images of CaCO₃ formed with various CaCl₂ concentrations (0.33 and 0.033 M) in the presence of 2 mg/mL TA after 5 and 60 min reaction while introducing 0.1 and 1 L/min CO₂ flow rate indicated that a uniform distribution of vaterite microspheres requires longer reaction time with a lower CaCl₂ concentration (0.033M), as shown in FIGS. 3A-3D.

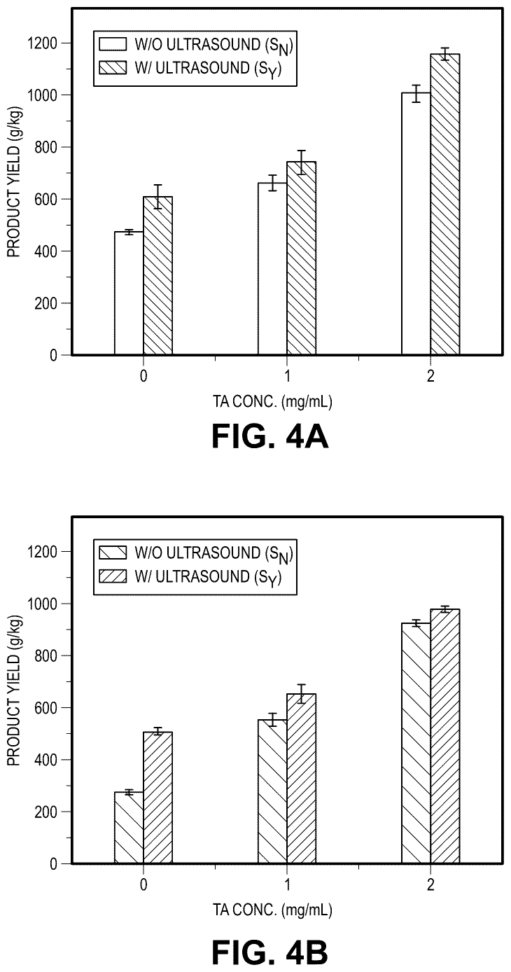

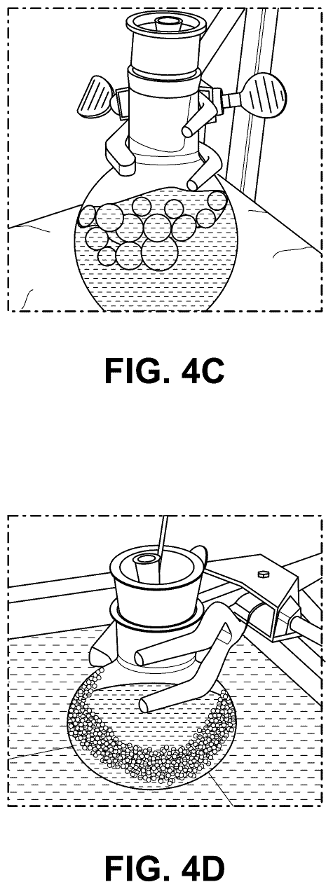

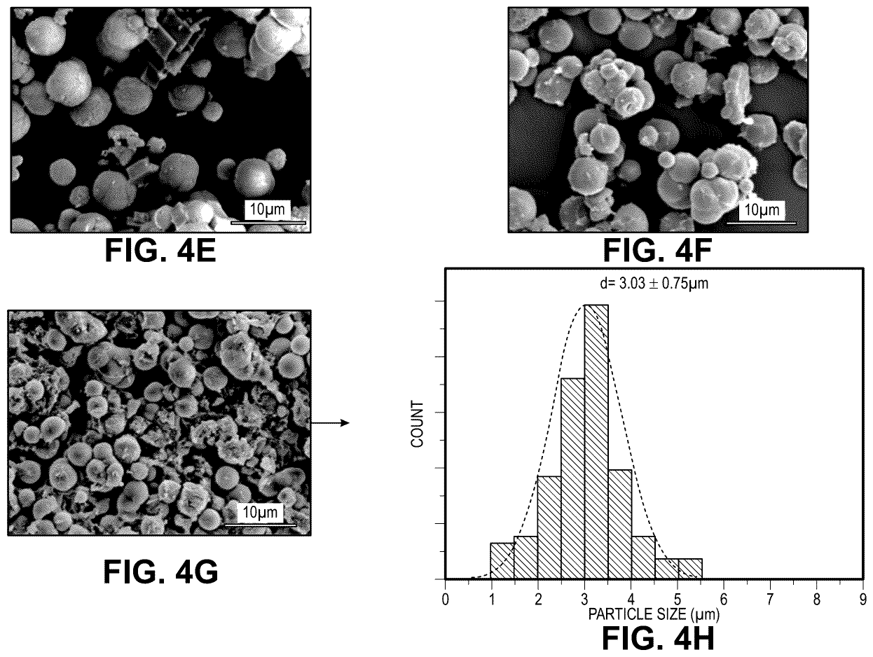

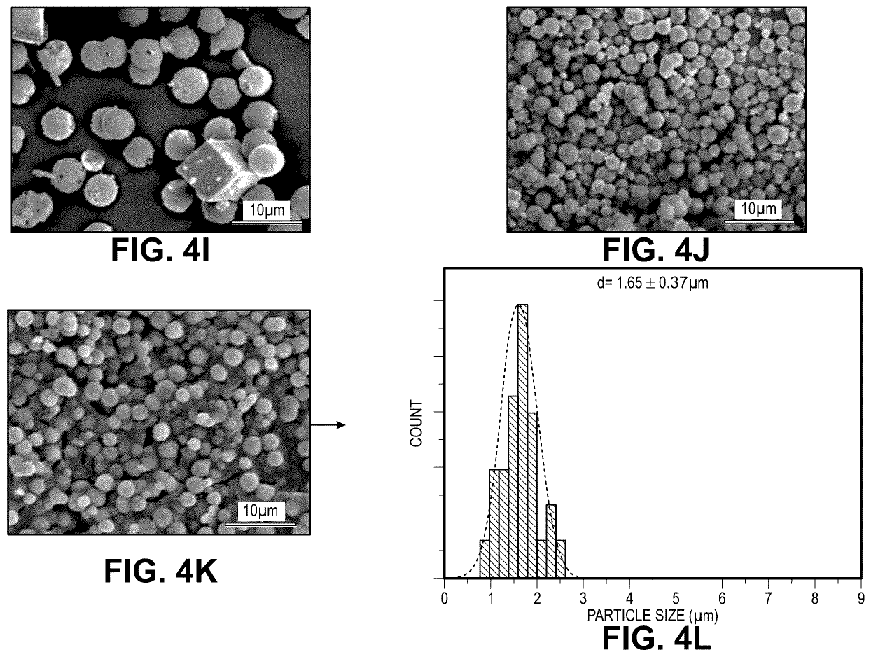

FIGS. 4A-4L Shows a series of plots and depictions of experiments directed to exploring product yield after 1 hour with TA concentrations of 0, 1, and 2 mg/mL under (FIG. 4A) 0.033 M CaCl₂ at 0.1 L/min CO₂, and (FIG. 4B) 0.033 M CaCl₂ at 1 L/min CO₂. Photos of CO₂ bubbling: (FIG. 4C) w/o and (FIG. 4D) w/ultrasonication in 2 mg/mL TA concentrations at 1 L/min CO₂. SEM images and particle size histogram of CaCO₃ crystals formed with 0.033 M CaCl₂ at 1 L/min CO₂ for (FIG. 4E) 0, (FIG. 4F) 1, (FIG. 4G) 2 mg/mL TA w/o ultrasonication and (FIG. 4I) 0, (FIG. 4J) 1, (FIG. 4K) 2 mg/mL TA w/ultrasonication, in accordance with the present disclosure.

The aforementioned phenomenon correlates with the Ca²⁺/CO₃²⁻ concentration ratio. Lowering this ratio—by increasing carbonate ion concentration through a higher/longer flow rate of CO₂ and decreasing Ca²⁺ concentration using a lower CaCl₂ concentration—promotes the formation and stabilization of vaterite. Based on these observations, subsequent experiments utilized a 1-hour reaction with 0.033 M CaCl₂ to evaluate the effects of ultrasonication on morphology, CaCO₃ yield. TA concentration and ultrasonication significantly influenced product yield, as represented in FIGS. 4A and 4B. Notably, product yield increased about threefold from 424.6 g/kg to 1173.8 g/kg in the presence of 2 mg/mL TA with a CO₂ flow rate of 0.1 L/min under sonication. A similar trend was observed at a CO₂ flow rate of 1 L/min, where the yield increased by about 4-fold, from 247.9 to 995.4 g/kg. This improvement can be attributed to TA's ability to promote nucleation and influence crystal growth. Moreover, the abundance of polar, oxygen-rich functional groups in TA promotes more efficient CO₂ absorption and dissolution because of their strong affinity for CO₂. Applying ultrasound further increased the reaction yield, both in the presence and absence of TA. We attribute this to acoustic cavitation, which accelerates reaction kinetics and enhances mass transfer within the liquid phase. Additionally, the use of ultrasound may improve CO₂ absorption and alter the mineralization pathway. Moreover, the particle size was also markedly affected by ultrasonication, as can be observed by comparing the particle size distributions found in FIGS. 4H and 4L, where d=3.03±0.75 microns, which is reduced to d=1.65±0.37 microns. This exhibits a smaller particle size as well as a more uniform distribution. Applying ultrasonication while increasing both the TA concentration to 2 mg/ml and CO₂ flow rate to 1 L/min reduced particle sizes from 3.03 μm to 1.64 μm (FIGS. 4E, 4F, 4G and FIGS. 4I, 4J, 4K). To identify the main factors controlling particle size, it is hypothesized that particle size could be correlate with CO₂ bubble diameter, supported by previous reports showing that gas bubbles can template the formation of CaCO₃ structures. Consequently, applying stronger perturbations that generate smaller bubbles provides a means to produce finer particles. Drawing inspiration from biomineralization processes in marine organisms, ultrasonication could generates highly localized microenvironments and induces cavitation, resulting in vigorous micro-mixing and precise control over nucleation dynamics. The observed reduction in particle size can be attributed to ultrasound-mediated cavitation, which promotes primary nucleation by reducing the induction time and also induces secondary fragmentation of growing particles, thereby increasing the number of available nucleation sites. Additionally, ultrasound significantly enhances gas-liquid interactions during CO₂ introduction by producing noticeably smaller bubbles that could serve as nucleation templates and accelerating CO₂ dissolution. In systems containing TA, these effects are amplified due to TA's polyphenolic, surfactant-like character, which adsorbs at bubble interfaces, lowers surface tension, and further encourages the generation of smaller CO₂ bubbles, as presented in FIGS. 4C and 4D. Collectively, these mechanisms limit the growth of individual crystals and favor the formation of uniformly smaller particles across the reaction medium.

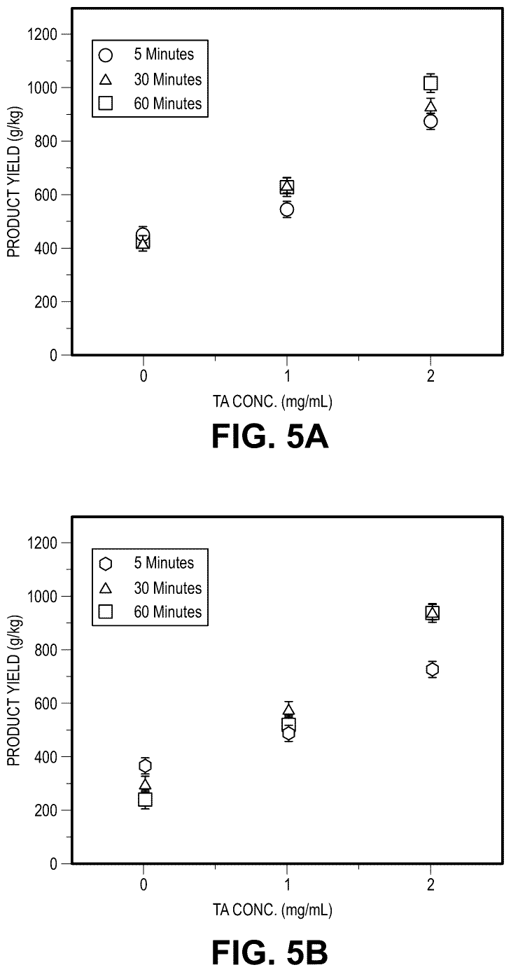

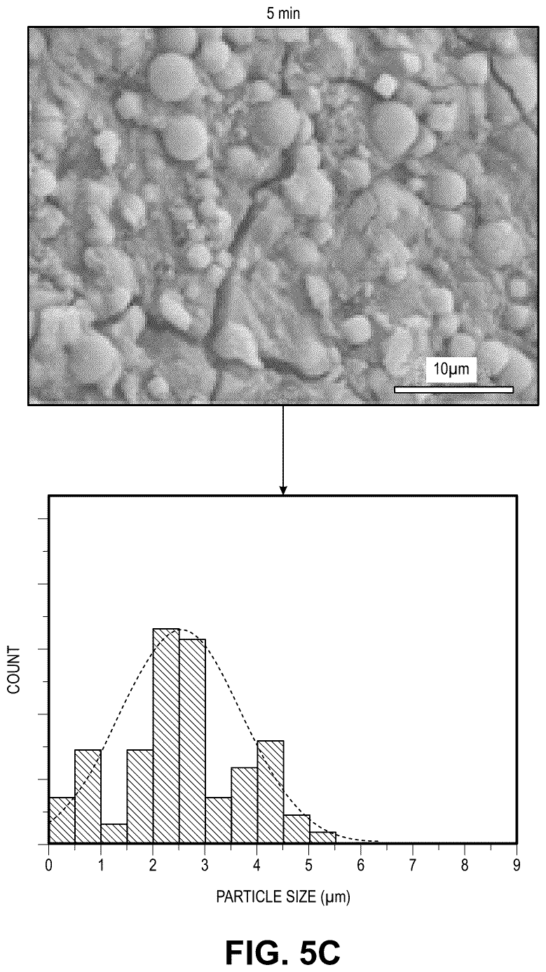

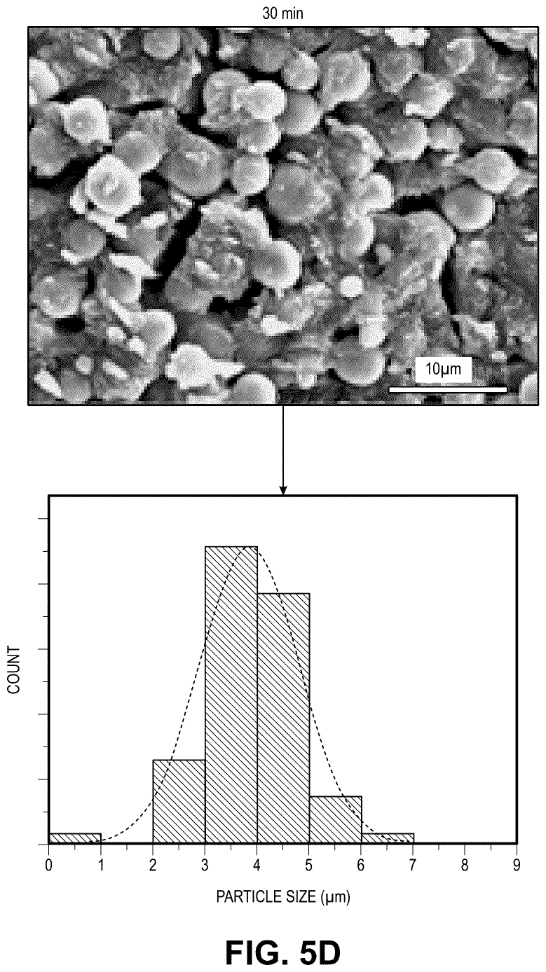

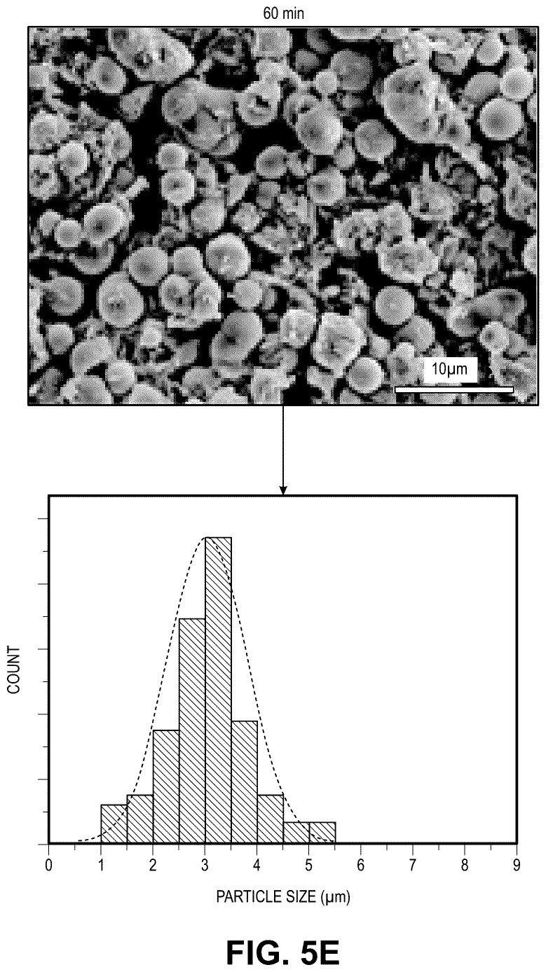

FIGS. 5A-5E depicts plots and SEM images of product yield after 5, 30 and 60 minutes with TA concentrations of 0, 1, and 2 mg/mL under (FIG. 5A) 0.033 M CaCl₂ at 0.1 L/min CO₂ and (FIG. 5B) 0.033 M CaCl₂ at 1 L/min CO₂. SEM images of CaCO₃ crystals formed with 0.033 M CaCl₂ at 1 L/min CO₂ with 2 mg/mL TA and W/O ultrasonication: (FIG. 5C) after 5 minutes, (FIG. 5D) after 30 minutes and (FIG. 5E) after 60 minutes, in accordance with the present disclosure.

Meanwhile, the strong chelation effect of tannic acid further facilitates Ca²⁺ ion supersaturation, resulting in higher yield and uniform distribution of micro-spherical vaterite particles. There was no significant reduction in particle size in the absence of TA, highlighting the role of TA in controlling the morphology of vaterite microspheres under ultrasonication. The reaction time was reduced to 30 and 5 minutes to optimize the bio-inspired mineralization process. The product yield showed no significant variation, indicating that mineralization can effectively occur within this shorter time frame (FIGS. 5A and 5B). However, the larger particle size with broader distribution observed at 5 and 30 minutes compared to the smaller and more uniformly distributed particles obtained after the 1-hour reaction time, in the presence of TA, may be attributed to the increased dissolution of particles over time, leading to the formation of finer particles with prolonged reaction durations, as shown in FIGS. 5C and 5E.

### CONCLUSION

The present teachings advance the production of spherical vaterite through bioinspired CO₂ mineralization using ultrasonication, with potential applications in coatings, construction, and pharmaceuticals. These findings contribute to energy conservation and waste management efforts while offering valuable insights into controlled mineral formation processes.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A carbon dioxide mineralization process, comprising:
introducing ammonium hydroxide solution and a calcium chloride solution into a reaction vessel to form a mixed solution;
introducing carbon dioxide gas into the reaction vessel; and
forming a calcium carbonate precipitate.

2. The carbon dioxide mineralization process of claim 1, wherein the mixed solution further comprises tannic acid.

3. The carbon dioxide mineralization process of claim 2, wherein a concentration of tannic acid is from about 0 mg/mL to about 2 mg/mL.

4. The carbon dioxide mineralization process of claim 1, wherein the process is conducted at a temperature from about 20° C. to about 30° C.

5. The carbon dioxide mineralization process of claim 1, wherein a flow rate of the introduction of carbon dioxide gas is from about 0 L/min to about 1.0 L/min.

6. The carbon dioxide mineralization process of claim 1, wherein a reaction time of the carbon dioxide mineralization process is from about 5 minutes to about 60 minutes.

7. The carbon dioxide mineralization process of claim 1, further comprising providing ultrasonic energy at a frequency of from about 20 khz to about 130 khz to the mixed solution.

8. The carbon dioxide mineralization process of claim 1, further comprising filtering the calcium carbonate precipitate through a polyvinylidene fluoride membrane.

9. The carbon dioxide mineralization process of claim 1, wherein a concentration of calcium chloride is from about 0.033 M to about 0.33 M.

10. The carbon dioxide mineralization process of claim 1, further comprising washing the calcium carbonate precipitate; and drying the calcium carbonate precipitate under a vacuum.

11. The carbon dioxide mineralization process of claim 1, wherein a particle size of the calcium carbonate precipitate is from about 0.5 microns to about 10 microns.

12. The carbon dioxide mineralization process of claim 1, wherein the calcium carbonate precipitate comprises a metastable vaterite phase.

13. A process for forming calcium carbonate, comprising:
introducing an ammonium hydroxide solution and a calcium chloride solution into a reaction vessel to form a mixed solution;
introducing carbon dioxide gas into the reaction vessel; and
forming a calcium carbonate precipitate, the calcium carbonate precipitate comprising a metastable vaterite polymorph phase.

14. The process for forming calcium carbonate of claim 13, wherein the mixed solution further comprises tannic acid.

15. The process for forming calcium carbonate of claim 14, wherein a concentration of tannic acid is from about 0 mg/mL to about 2 mg/mL.

16. The process for forming calcium carbonate of claim 13, wherein a flow rate of the introduction of carbon dioxide gas is from about 0.1 L/min to about 1.0 L/min.

17. The process for forming calcium carbonate of claim 13, further comprising providing ultrasonic energy at a frequency of 42 kHz to the mixed solution.

18. The process for forming calcium carbonate of claim 13, wherein a concentration of calcium chloride is from about 0.033 M to about 0.33 M.

19. The process for forming calcium carbonate of claim 13, further comprising washing the calcium carbonate precipitate; and drying the calcium carbonate precipitate under a vacuum.

20. The process for forming calcium carbonate of of claim 13, wherein:
a yield of the calcium carbonate precipitate is from about 246.7 g/kg to about 1173.8 g/kg; and
a particle size of the calcium carbonate precipitate is from about 0.5 microns to about 6 microns.
